(19) United States
(12) Patent Application Publication
(10) Pub. No.: US 2018/0150187 A1
(43) Pub. Date: May 31, 2018

(54) METHOD AND APPARATUS FOR PROVIDING A USER INTERFACE

(71) Applicant: JSC INTERNATIONAL TOBACCO MARKETING SERVICES, Moscow (RU)

(72) Inventors: Nikolay ARTEMYEV, Moscow (RU); Yulia AETEMYEVA, Moscow (RU); Alexander DEMCHUK, Moscow (RU); Tatevik MAYTESYAN, Moscow (RU); Roksana OLSINSKAYA, Moscow (RU)

(21) Appl. No.: 15/566,869

(22) PCT Filed: Apr. 14, 2016
(86) PCT No.: PCT/GB2016/051041

§ 371 Date: Oct. 16, 2017

(30) Foreign Application Priority Data
Apr. 17, 2015 (RU) 2015114533
Apr. 17, 2015 (RU) 2015114538

(51) Int. Cl. G06F 3/0481; G06F 3/0487

(52) U.S. Cl. CPC G06F 3/0481; G06F 3/0487

(57) ABSTRACT

Methods, apparatus and systems are presented that provide a user interface to a user terminal. User interfaces are provided upon electromagnetic interrogation of one or more interrogatable data storages. A method is presented that bases a second user interface, that is different to a first user interface associated with first data, upon second data and data associated with the receiving of the first data. A method is presented that provides a user interface configured to initiate user access to a first interactive session with a program. A method is presented for outputting data from a user terminal a remote computer system upon electromagnetic interrogation of a data storage by a user terminal. A packaging for a smoking article is also presented.

The present invention is in the field of providing user interfaces, in particular, but not exclusively, providing user interfaces initiated by the electromagnetic interrogation of one or more data storage devices.

### BACKGROUND

Data storage media exist in a variety of forms. Data held in storage media may be read by devices and used in the performance of computational operations by a processor. One form of data storage is an electromagnetically interrogatable data storage that stores data that can be accessed by an electromagnetic interrogating device. An example of such an interrogatable data storage is an RFID tag containing data that can be read by bringing an electronic induction coil into proximity with the tag. The data extracted from existing interrogatable storage devices may be used for various applications. One example is storage media on bank cards that can be accessed via a payment terminal where funds are automatically deposited from a user bank account upon interrogating the card with the payment terminal.

Subsequent interrogation of the RFID tags in the above examples provide the user or the terminal with the same access procedures with the remote system each time the terminal interrogates a new tag or when the same tag is interrogated by a different interrogating device. Such existing systems do not take into account multiple reading of the same tag or multiple readings of different tags from the same device. This may lead to system inefficiencies or improper usage of the data stored in the data storage.

### SUMMARY

In a first aspect of the invention there is provided a method for providing a user interface to a user terminal based on an electromagnetic interrogation of one or more interrogatable data storage devices; the method comprising the steps of: receiving first data output from a user terminal associated with a first electromagnetic interrogation of an interrogatable data storage; outputting a first user interface to the user terminal based on the first data; receiving second data output from the user terminal, the second data associated with a second electromagnetic interrogation of an interrogatable data storage; outputting a second user interface to the user terminal, the second user interface being different to the first user interface and based on: the second data and, data associated with the receiving of the first data.

The first aspect may be modified in any suitable way as disclosed herein including but not limited to any one or more of the following.

The method as may be configured such that: the first user interface is configured to receive user data for interacting with a program associated with the user interface; the second data comprises data associated with the user data.

The method may comprise the steps of: upon outputting the first user interface to the user terminal, receiving user data input through the first user interface; performing a first computational operation using the user data; wherein the second user interface is further based upon the performance of the first computational operation.

The method may be configured such that the steps of receiving first and second data and outputting first and second user interfaces are performed using one or processors remote from the user terminal.

The method may be configured such that the one or more processors comprise part of a remote system running a user interactive program accessible through the first and second user interfaces.

The method may be configured such that the user terminal is a mobile user device.

The method may be configured such that the one or more interrogatable data storages comprises interrogatable data configured to instruct the receiving user terminal to output the corresponding first or second data.

The method may be configured such that the one or more interrogatable data storages comprises interrogatable data configured to instruct the receiving user terminal to determine location data associated with the user terminal.

The method may be configured such that the one or more interrogatable data storages comprises interrogatable data configured to instruct the receiving user terminal to determine time value associated with the interrogation of the corresponding data storage.

There is also presented a computer readable product comprising instructions configured to give effect to the method as described according to the first aspect.

In a second aspect of the invention there is provided an apparatus for providing a user interface to a user terminal based on an electromagnetic interrogation of one or more interrogatable data storage devices; the apparatus comprising a processor and configured to: receive first data output from a user terminal associated with a first electromagnetic interrogation of an interrogatable data storage; output a first user interface to the user terminal based on the first data; receive second data output from the user terminal, the second data associated with a second electromagnetic interrogation of an interrogatable data storage; output a second user interface to the user terminal, the second user interface being different to the first user interface and based on: the second data and, data associated with the receiving of the first data.

The second aspect may be modified in any suitable way as disclosed herein including but not limited to any one or more of the optional features described according to the first aspect.

A system is presented comprising the apparatus as described in the second aspect and the user terminal.

In a third aspect of the invention there is provided a method for providing a user interface configured to initiate user access to an interactive session with a program; the method comprising the steps of: receiving first data from a first user terminal, the first data associated with a first electromagnetic interrogation of an interrogatable data storage; providing a first user interface to the first user terminal, the first user interface configured to initiate user access to a first interactive session with the program, the first interactive session based upon the first data; receiving second data from a second user terminal; the second data associated with a second electromagnetic interrogation of an interrogatable data storage; determining a state of the first interactive session; providing a second user interface to the second user terminal, the second user interface configured to initiate user access to a second interactive session with the program, the second interactive session based upon: the determined state of the first interactive session; and, the second data.

The third aspect may be modified in any suitable way as disclosed herein including but not limited to any one or more of the optional features described according to the first aspect and any of the following.

The method may be configured such that the state of the first interactive session may be any of: not having started; started but not yet completed; completed.

The method may be configured such that the user terminal comprises a memory; the method comprising the step of storing data associated with the determined state of the first interactive session in the memory.

The method may be configured such that: the first interactive session comprises a first computational operation using the first data; and, the second interactive session comprises a second computational operation: using the second data; and, based upon the first computational operation.

In a fourth aspect of the invention there is provided an apparatus for providing a user interface configured to initiate user access to a first interactive session with a program; the apparatus comprising a processor, the apparatus configured to: receive first data from a first user terminal, the first data associated with a first electromagnetic interrogation of an interrogatable data storage; provide a first user interface to the first user terminal, the first user interface configured to initiate user access to a first interactive session with the program, the first interactive session based upon the first data; receive second data from a second user terminal; the second data associated with a second electromagnetic interrogation of an interrogatable data storage; determine, using the processor, a state of the first interactive session; provide a second user interface to the second user terminal, the second user interface configured to initiate user access to a second interactive session with the program, the second interactive session based upon: the determined state of the first interactive session; and, the second data.

The fourth aspect may be modified in any suitable way as disclosed herein including but not limited to any one or more of the optional features described according to the first and third aspects.

There is also presented a system comprising an apparatus as described in the fourth aspect and the first and second user terminals.

In a fifth aspect of the invention there is provided a method for outputting data from a user terminal; the method comprising the steps of: receiving storage data from an interrogatable data storage upon the electromagnetic interrogation of the data storage by the user terminal; in any order: determining any of: location based data associated with the user terminal; and/or time based data associated with the interrogation of the interrogatable data storage; establishing a communication link between the user terminal and a remote computer system based on the storage data; outputting the determined data to the remote computer system.

The fifth aspect may be modified in any suitable way as disclosed herein including but not limited to any one or more of the following optional features.

The method may be configured such that the remote system is configured to run a program; the method comprising the steps of: providing a user interface to the user terminal for interacting with the program, upon establishing a communication with the remote computer system.

The method may be configured such that the user interface is configured to determine the location or time based data.

There is presented herein a user terminal comprising a processor configured to perform the method as described in the fifth aspect.

In a sixth aspect of the invention there is provided packaging for a smoking article, the packaging comprising an electromagnetically interrogatable data storage device; the interrogatable data storage device configured to output data upon electromagnetic interrogation by an electromagnetic interrogator associated with a user terminal; the output data configured to instruct the user terminal to: establish a communication link to a remote processor; and determine any of: user terminal location data; timing information associated with the electromagnetic interrogation; for outputting to the remote processor.

The sixth aspect may be modified in any suitable way as disclosed herein including but not limited to any one or more of the following optional features.

The packaging may be configured such that the electromagnetically interrogatable data storage comprises an RFID.

The packaging may be configured such that the data output, upon electromagnetic interrogation, comprises a website address.

The packaging may be configured such that the data output, upon electromagnetic interrogation, comprises a identification data associated with the packaging.

### BRIEF DESCRIPTION OF THE DRAWINGS

Embodiments of the invention will now be described, by way of example only, with reference to accompanying drawings, in which:

FIG. 1 shows an example of a system as presented herein;

FIG. 2a is an example of a system as presented herein, wherein a mobile phone is used to interrogate a product package having an RFID;

FIG. 2b is an example of a system as presented herein, wherein a static user terminal in connection with a RFID reader is used to interrogate a product package having an RFID;

FIG. 3 is an example of a product package with a RFID;

FIG. 4a is an example of a user interface page allowing a user to register;

FIG. 4b is an example of a user interface page allowing a user to log in;

FIG. 5 is an example of an interactive page displayed via a user interface;

FIG. 6 is an example of a method as presented herein;

FIG. 7 is another example of a method as presented herein;

FIG. 8 is a further example of a method as presented herein;

FIG. 9 is an example of a system as presented herein;

FIG. 10 is another example of a system as presented herein; and

FIG. 11 is a further example of a system as presented herein.

### DETAILED DESCRIPTION

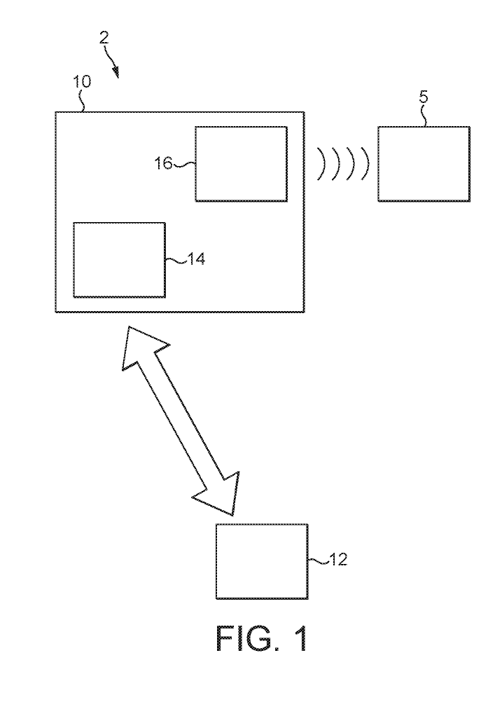

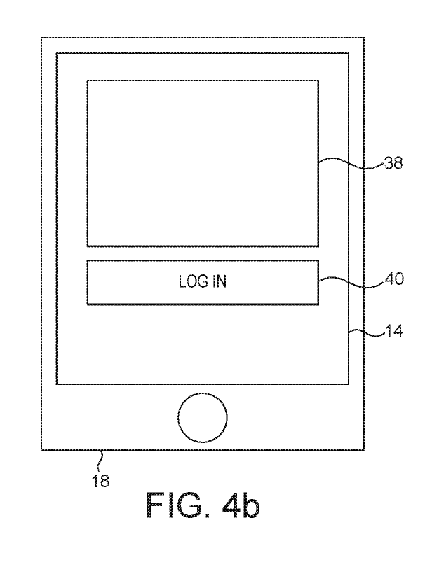

There is presented herein a method 1 for providing a user interface 14 to a user terminal 10 based on an electromagnetic interrogation of one or more interrogatable data storage devices 5. An example of this method 1 is shown in FIG. 1. An example flowchart of this method 1 is shown in FIG. 6. The method 1 comprises the step of receiving 102 first data output from a user terminal 10 associated with a first electromagnetic interrogation of an interrogatable data storage 5. The method 1 then outputs 104 a first user interface 14 to the user terminal 10 based on the first data. The method 1 then receives 106 second data output from the user terminal 10, the second data associated with a second electromagnetic interrogation of an interrogatable data storage 5. The method 1 then outputs 108 a second user interface 14 to the user terminal 10 wherein the second user interface 14 is different to the first user interface 14. The second user interface 14 is based on the second data and data associated with the receiving of the first data.

The method 1 therefore allows the same user terminal 10 to be sent different user interfaces 14 based upon whether or not a first set of data has already been sent from the user terminal 10 arising from a previous electromagnetic interrogation of an interrogatable data storage 5.

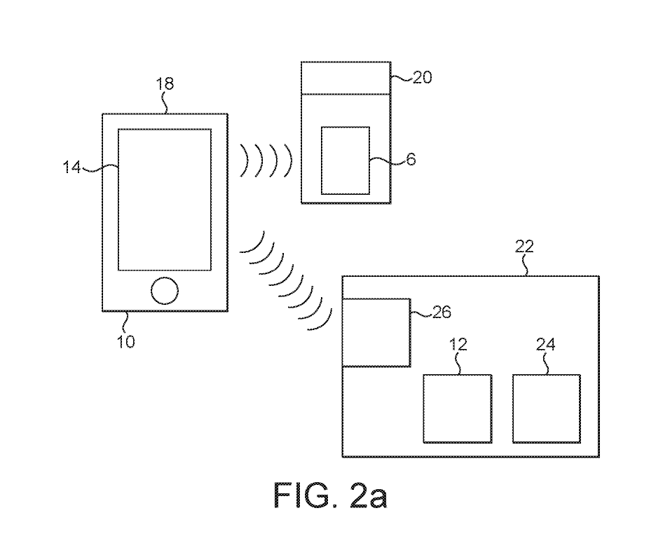

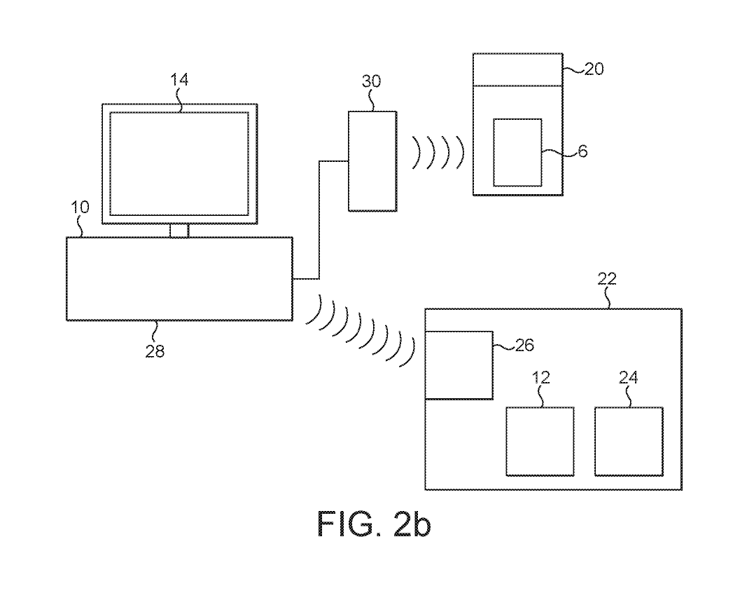

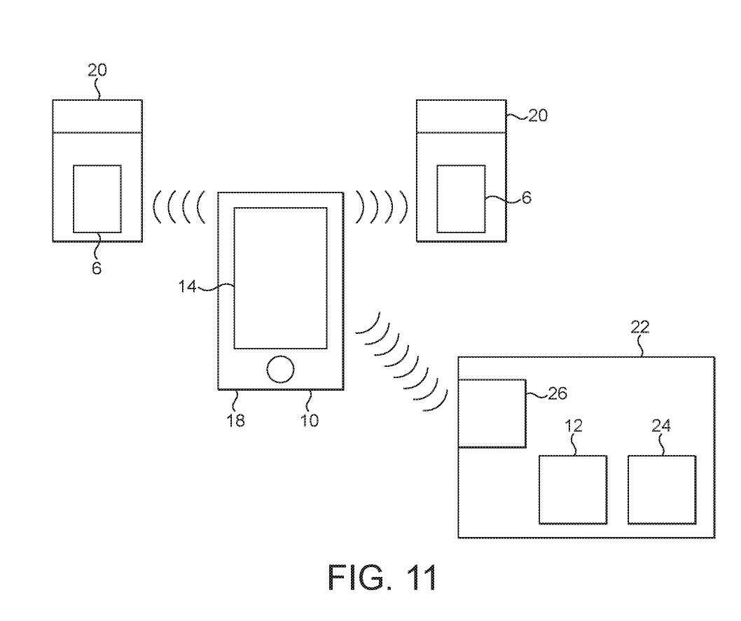

One example of this method 1 is a mobile device 18 having an electromagnetic interrogator 16 that is used to electromagnetically interrogate a data storage 5 that takes the form of an RFID 6 as shown in FIG. 2a. Different interrogations of data storages 5 may be interrogations of the same storage 5 or different data storages 5 as shown in FIG. 11. The steps and features of this example may be added to or modified according to any suitable steps of features described elsewhere herein. The RFID in this example is affixed to a product package 20, such as a package for one or more smoking articles. An example of a product package 20 with an RFID 6 is shown in FIG. 3 wherein the RFID 6 contains an memory 7 connected to an inductive coil 8. The memory 7 contains electronic data that can be read, through the inductions coil 8 when electromagnetically interrogated.

The electromagnetic interrogation in this example is achieved by a user tapping the mobile device 18 against the RFID 6, or otherwise bringing the mobile device 18 into close proximity with the RFID 6. The mobile device 18 has an antenna (not shown in FIG. 2a) that acts as an electromagnetic interrogator 16 that can interrogate the RFID 6 and extract the data stored within the memory 7. The mobile device 18 in this example is a mobile phone with an antenna that can be used both for standard mobile communications and as an electromagnetic interrogator 16. In this example the technology used to interrogate the RFID is based upon Near Field Communication (NFC). The mobile device 18 also has computer processing components, such as a processor and memory and associated controlling circuitry and devices, that runs one or more software programs that causes the mobile device 18 to electromagnetically excite, and read data from, the RFID 6. The programs are also configured to automatically act upon the data uploaded from the RFID 6 interrogation. In this example the interrogated data contains a website address and a unique product ID code associated with the product package 20 that the RFID 6 is affixed to. Upon reading this interrogated data, the mobile device 18 opens up an internet browser program and uses the website address to access a remote system, which in this example is a remote server 22 that supports a website user interface 14.

In principle, the first data received by the server 22 (upon the interrogation of the data storage 5) may be any data including data providing details of the mobile device that allows or otherwise instructs the server to send a first user interface 14 back to the mobile device 18.

The server 22 in this example comprises a processor 12, memory 24 for running one or more programs having a website that provides various different user interface pages (also referred to as first, second and subsequent user interfaces) that a mobile user can interact with. The server 22 also has access to a communications device 26 for sending and receiving data from the mobile device 18.

The user interface 14 pages sent to the mobile device 18 may allow the user to do a variety of things by interacting with interactive elements on the user interface that cause the performance of one or more computational operations or processes by the server processor 12.

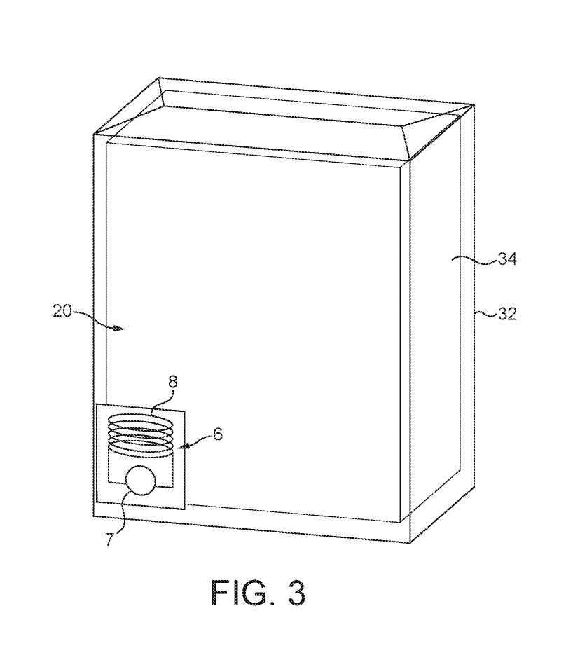

In one example shown in FIG. 4a the user is presented a user interface 14 on the mobile phone wherein the user interface 14 provides interactive functionality for the user to enter registration information that may be uploaded to the website. In FIG. 4a the user is presented with an interactive graphical element 36 that the user can select. Upon selection of this element 36 the user may be provided with a further interface 14 to enter their details. Alternatively the selection of the registration element 36 may automatically determine or retrieve stored user details on the mobile device 18 and upload them to the server. In turn, the website program running on the server may send back login details via a user interface that the user can use the next time they interact with the same program, thus not having to register again.

In another example, the user may be presented with a login user interface 14 as shown in FIG. 4b. Similarly to the example shown in FIG. 4a, the user can select an interactive element 40 to initiate the login process.

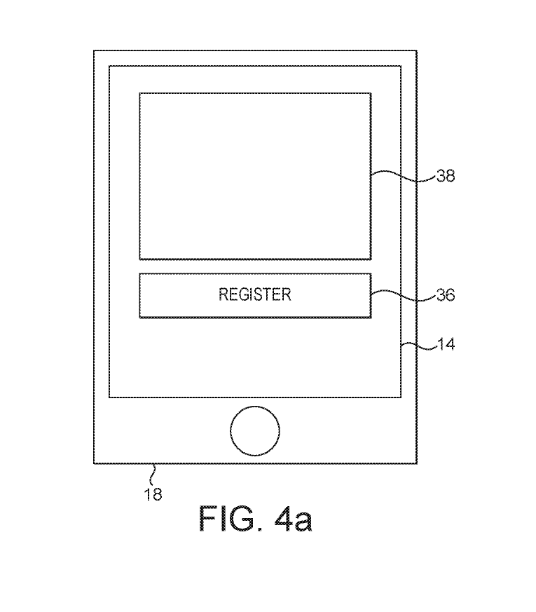

In another example, the user may already be registered and logged into the website and is presented with a variety of optional tasks or computations that they can interact with. The user interface 14 presented to the user may have features allowing the user to navigate through the different options such as graphical menus and tabs. The tasks presented via the user interface 14 may be optional or compulsory for the user to perform, i.e. if compulsory, the user has to interact with and perform the computational task before they are allowed to continue using the website. An example of such an interactive computation task presented through the user interface 14 s shown in FIG. 5 where the user is asked to rate the product by selecting an interactive element 42. The selection of this element 42 may, in turn lead to various other user interface pages 14 being presented to the user to for inputting user information or choices that the website program uses to calculate a user rating for the product 20 that the user has just interrogated with the mobile device 18.

The data associated with the receiving of the first data may be, for example, a stored log of the first data uploaded to the server (this could be the unique product ID code or the details about the mobile device that allows the server 22 to communicate with the mobile device 18.

Additionally or alternatively, the data associated with the receiving of the first data may be the output of a computational operation performed using the first data,

Additionally or alternatively, the data associated with the receiving of the first data may be the output of a computational operation performed using subsequent data received through the first user interface. For examples any of the data stored as a result of the registration, login or ‘rate product’ examples described above.

In a similar manner, each successive interrogation of the same (or a different) RFID by the user terminal may cause the user terminal to establish a new connection with the remote server and display on its graphical display a user interface associated with the website.

Similarly to the sending of the first data, the second data uploaded to the server may be data including, but not limited to data providing details of the mobile device that allows or otherwise instructs the server 22 to send the second user interface 14 back to the user terminal.

As before, the server 22 sends the second user interface 14 to the mobile device 18, however the second user interface 14 is different to the first user interface 14 because the method 1 takes into account the abovementioned data associated with the receiving of the first data. The ‘data associated with the receiving of the first data’ may be used to do any of: modify the first user interface to form the second user interface; select the second user interface for outputting; or otherwise cause the second user interface to be generated and output to the user terminal.

In one example, the first data output by the mobile device 18 (associated with a first electromagnetic interrogation of the RFID 6) includes data identifying the user of the mobile device. The server identifies that the user of the mobile device has not been registered and therefore sends the mobile device 18 a user interface page 14 similar to that shown in FIG. 4a allowing the user to input registration information. The server 22 processes the registration information input via first user interface and sends back login information to display to the user as well as data (such as a cookie) to be stored on the mobile device 18 associated with the registration details that can be used to bypass the registration process the next time a user interrogates an RFID. Upon a second interrogation of the same or different RFID tag, the same user identification details (second data) are uploaded to the server from the mobile device as well as the bypass data. The server 22 identifies that user is already registered and sends a login user interface 14 page similar to that shown in FIG. 4b.

In another example the first data (associated with a first electromagnetic interrogation of the RFID 6) uploaded to the server includes the unique product identification code associated with product the RFID is affixed to. The user is already shown as logged into the website program and is presented with a user interface 14 similar to that shown in FIG. 5 requesting that the user ‘rate product’ as this is the first time that the product ID has been sent to the server 22. The user interacts with the website and completes the rate product computational operations via interacting with a set of user interfaces provided to the mobile device 18. After successfully completing the rating process, the rating is stored in the server memory 24 and the user's registered account is provided with points that the user can use to purchase or access online items such as music or computer games. The rating in this example could be an example of the ‘data associated with the receiving of the first data’. While still logged in, the user then re-interrogates the same RFID in an attempt to gain more points. The server identifies that the product has already been rated and sends a second user interface 14 that is different to the first user interface 14 in that the ‘rate product’; interactive button is not displayed.

In one example the one or more interrogatable data storages comprises interrogatable data configured to instruct the receiving user terminal to output the corresponding first or second data.

In another example, the one or more interrogatable data storages comprises interrogatable data configured to instruct the receiving user terminal to determine location data associated with the user terminal (for example GPS data).

In another example, the one or more interrogatable data storages comprises interrogatable data configured to instruct the receiving user terminal to determine a time value associated with the interrogation of the corresponding data storage.

There is also provided an apparatus for providing a user interface to a user terminal based on an electromagnetic interrogation of one or more interrogatable data storage devices; the apparatus comprising a processor and configured to: receive first data output from a user terminal associated with a first electromagnetic interrogation of an interrogatable data storage; output a first user interface to the user terminal based on the first data; receive second data output from the user terminal, the second data associated with a second electromagnetic interrogation of an interrogatable data storage; output a second user interface to the user terminal, the second user interface being different to the first user interface and based on: the second data and, data associated with the receiving of the first data.

The apparatus may be part of a system that may also include the one or more interrogatable devices (and optionally associated product packages).

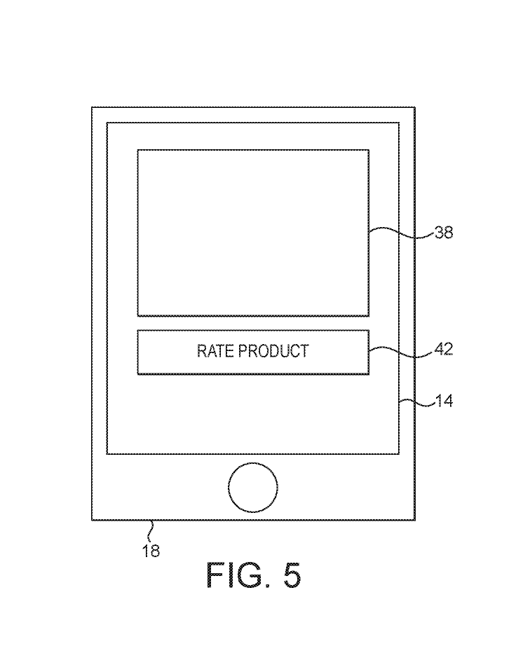

Also presented herein is a method 3 for for providing a user interface configured to initiate user access to a first interactive session with a program. An example of the method 3 is shown in FIG. 7. The method comprises the step of receiving 202 first data from a first user terminal, the first data associated with a first electromagnetic interrogation of an interrogatable data storage. The method also comprises the step of providing 204 a first user interface to the first user terminal, the first user interface configured to initiate user access to a first interactive session with the program, the first interactive session based upon the first data. The method also comprises the step of receiving 206 second data from a second user terminal; the second data associated with a second electromagnetic interrogation of an interrogatable data storage. The method also comprises the steps of determining 208 a state of the first interactive session and then providing 210 a second user interface to the second user terminal, the second user interface configured to initiate user access to a second interactive session with the program, the second interactive session based upon: the determined state of the first interactive session; and, the second data.

Similar to the examples described for the method 1 described above, where the user interacts with a website program via one or more interfaces, this method 3 bases the initiation of an interactive session based on the state of a previous interactive session started through a different user terminal. An interactive session may be determined in a number of ways including, but not limited to: the duration of a user interacting with a particular computational task through a user interface 14 (beginning with the start of the task and ending with the completion of the task); the duration of the user interacting with the program running on the server (via user interface pages) starting upon the first interface being provided to the user terminal or upon the user successfully logging into the program (e.g. after successfully completing the login user interface as shown in FIG. 4b). The state of the session may be determined in any suitable way including examining data (for example a cookie) stored on a user terminal 10 or the server 22.

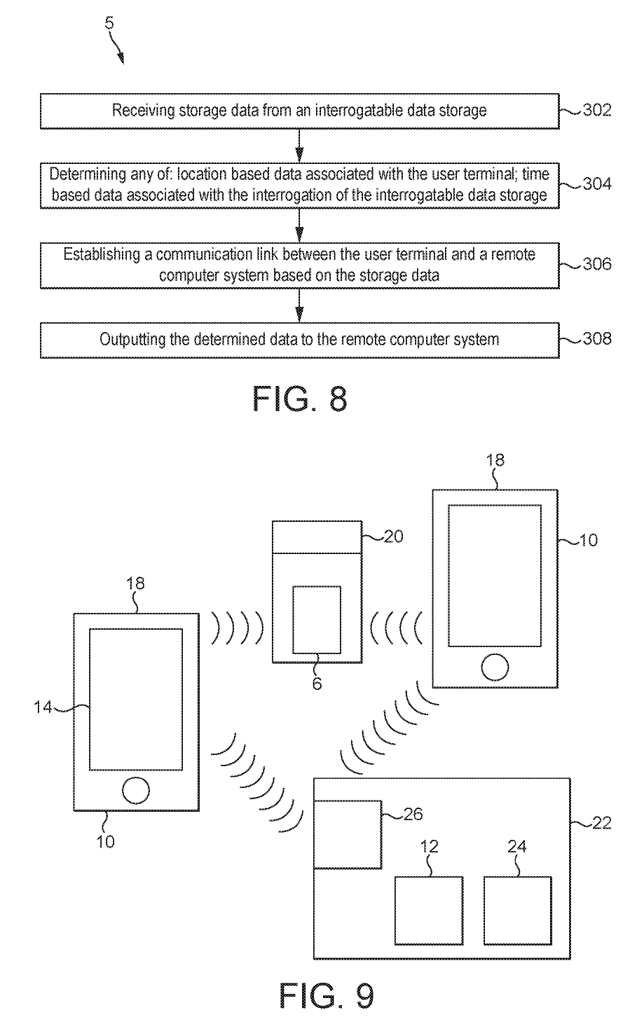

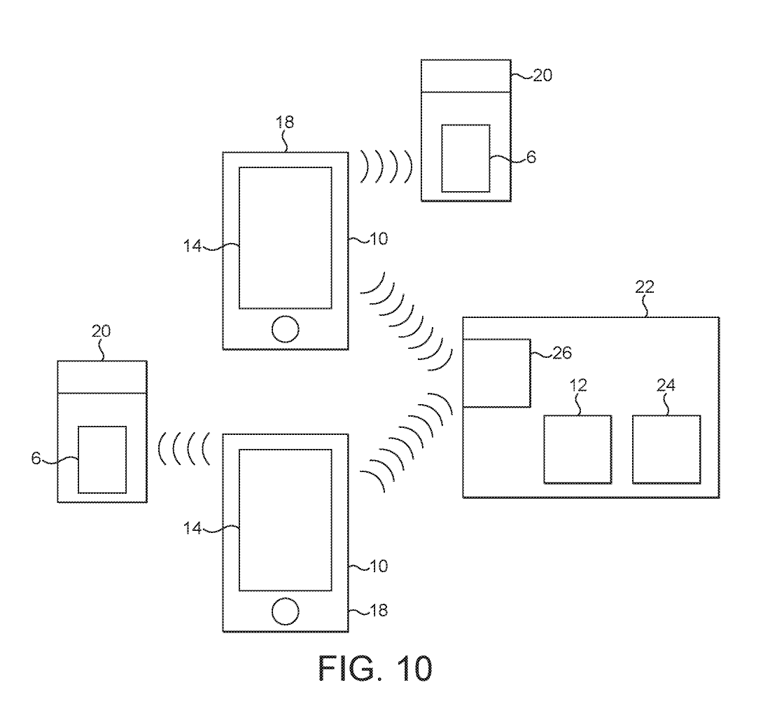

An example of the method 3 is now provided using features similar to any of the examples described herein, including the examples used above for method 1. In this example, the user has two user terminals 10 that are logged into the website program. The user terminals may have connected with the server upon interrogating a common RFID as shown in FIG. 9 or by interrogating different RFIDs as shown in FIG. 10. The first and second data may be any data as described elsewhere herein including, but not limited to previously stored user login data or data identifying the user terminal On one terminal the user is already accessing and interacting with computation task that allows the user to interactively use accumulated points (resulting from the interrogation of the RFID tags). The start of this first session to perform the task was recorded by the server. The user then tries to initiate access to a second interactive session of the same task on the second terminal 10. The server 22 detects this request and identifies the data showing that an equivalent session has already been started and has not yet completed. Upon determining the state of the first session, the server provides a user interface to the second user terminal 10 preventing access to this task.

In one example, the state of the first interactive session may be any of: not having started; started but not yet completed; completed.

In one example, the user terminal comprises a memory; the method 3 comprising the step of storing data associated with the determined state of the first interactive session in the memory.

In one example, the first interactive session comprises a first computational operation using the first data; and, the second interactive session comprises a second computational operation: using the second data; and, based upon the first computational operation.

There is also presented herein an apparatus for providing a user interface configured to initiate user access to a first interactive session with a program; the apparatus comprising a processor, the apparatus configured to: receive first data from a first user terminal, the first data associated with a first electromagnetic interrogation of an interrogatable data storage; provide a first user interface to the first user terminal, the first user interface configured to initiate user access to a first interactive session with the program, the first interactive session based upon the first data; receive second data from a second user terminal; the second data associated with a second electromagnetic interrogation of an interrogatable data storage; determine, using the processor, a state of the first interactive session; provide a second user interface to the second user terminal, the second user interface configured to initiate user access to a second interactive session with the program, the second interactive session based upon: the determined state of the first interactive session; and, the second data.

A system may be provided comprising the apparatus and the first and second user terminals.

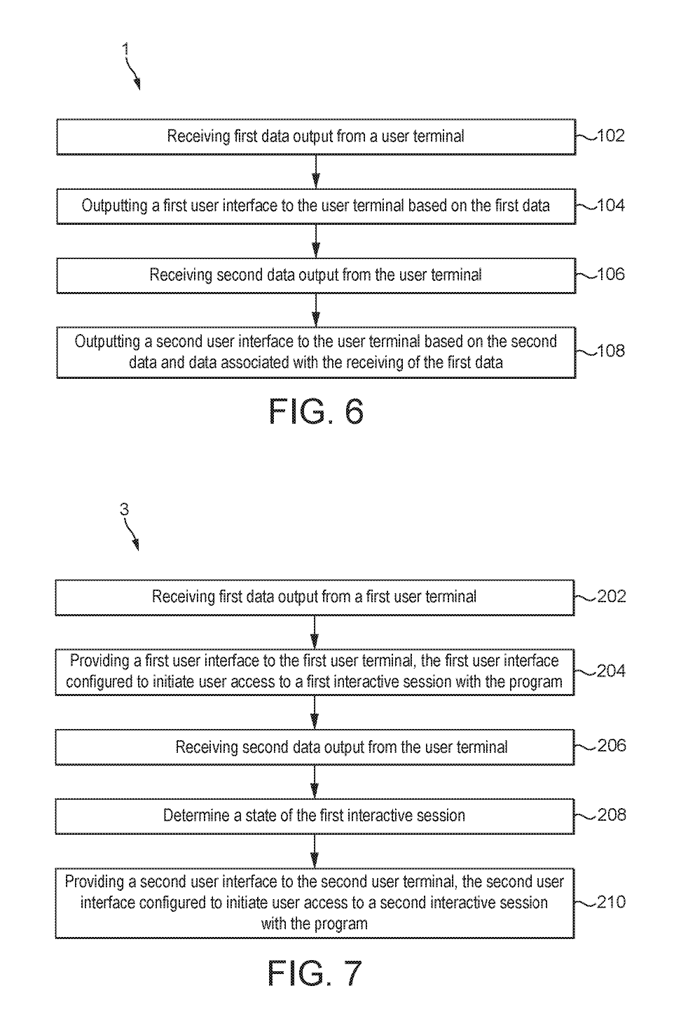

There is also provided herein a method 5 for outputting data from a user terminal. FIG. 8 shows an example of such a method 5. The method comprising the steps of: receiving 302 storage data from an interrogatable data storage upon the electromagnetic interrogation of the data storage by the user terminal; in any order: determining 304 any of: location based data associated with the user terminal; and/or time based data associated with the interrogation of the interrogatable data storage; establishing 306 a communication link between the user terminal and a remote computer system based on the storage data; outputting 308 the determined data to the remote computer system.

In one example, the remote system is configured to run a program; the method comprising the steps of: providing a user interface to the user terminal, upon establishing a communication with the remote computer system.

In one example, the user interface is configured to determine the location or time based data.

This method 5 may be used or modified according to the features described elsewhere herein.

There is also presented herein a packaging for a smoking article, the packaging comprising an electromagnetically interrogatable data storage; the interrogatable data storage configured to output data upon electromagnetic interrogation by an electromagnetic interrogator associated with a user terminal; the output data configured to instruct the user terminal to: establish a communication link to a remote processor; determine any of: user terminal location data; timing information associated with the electromagnetic interrogation; for outputting to the remote processor. An example of such a packaging is shown in FIG. 3. Such packaging may be used in any other method or example described herein.

In one example, the electromagnetically interrogatable data storage comprises an RFID.

In one example, the data output, upon electromagnetic interrogation, comprises a website address.

In one example, the data output, upon electromagnetic interrogation, comprises a identification data associated with the packaging.

A computer readable medium is presented that comprises computer readable instructions configured to give effect to any one or more of the methods described herein.

In one example, the user terminal may be a terminal used by the vendor of a product that contains the data storage. Upon the sale of that product, the vendor interrogates the sold product, which in turn causes the user terminal to upload data to a remote server indicating the successful completion of the sale. This data may be sent alongside any other data described in other examples described herein. The server may in turn provide a user interface to the vendor's user terminal for the vendor to interact with (for example further inputting information about the sale or the product). In one example, both the vendor and consumer who purchased the product may interrogate the same data storage, in a similar way as described in other examples described herein. The server may compare the data received from both the vendor and consumer user terminals and output a user interface to the any of the user terminals based on the comparison. For example sending a user interface allowing the vendor to register the purchase only when both data sets comprise the same product identifier code.

Any of the above methods, apparatus and systems and their associated examples may be modified in any suitable way, including, but not limited to, using any suitable features of any other examples described herein, including but not limited to any of the following features or items.

### Electromagnetically Interrogatable Data Storage Device

In principle the electromagnetically interrogatable data storage 5 (also referred to as ‘data storage’ and ‘data storage device’ herein) may be any electromagnetically interrogatable device that is configured to output data upon interrogation with an electromagnetic signal. The data storage 5 may be an active device which can by itself initiate communication steps, for example initiating a communication with another active device. The data storage 5 may be a passive device which only outputs data when interrogated. The data storage may be a read only, such as a read only passive device. Alternatively the data storage may be a read/write device, such as a read/write passive device. The data may be stored in any format including being electronically stored or stored within a material that can be optically interrogated.

The data storage 5 may be associated with another item such as a product 20. An example of a product is a packaging item 21 used to house products. An example of such product packaging 21 is a package for a smoking article as shown in FIG. 3. The data storage 5 may be located on the outside on the package 21, in between packaging layers such as between an outer packaging layer 32 and an inner packaging layer 34. Alternatively the data storage 5 may be located inside the internal space defined by the innermost packaging layer 34. When inserted into the internal space, the data storage 5 may be located upon an item, such as a card or film. Such a further item may be designed to fit within the package 21, for example via an interference fit within the packaging walls.

Examples of data storage 5 include optical data storage such as holographic data storage. An example of holographic technology is that similar to holographic versatile disc (HVD). Other optical technologies may be used including barcode technologies. Electromagnetic interrogator devices used to read such optical devices may include a laser.

Examples of data storage 5 include electronic devices such as Bluetooth® devices and RFID tags 6. RFID tags 6 generally have an integrated circuit (IC) chip 7 connected to an antenna or inductive coil 8. The IC chip 7 includes non-volatile memory which stores a code. An electromagnetic interrogator such as a mobile device 18 with an antennae (such as a mobile phone shown in FIG. 2a) or an RFID reader 30 as shown in FIG. 2b may be used to interrogate the tag by transmitting a radio frequency signal which is received at the antenna or inductive coil. The RFID tag then returns a signal to the RFID reader containing the locally stored code. The RFID therefore collects energy from the interrogating radio waves and act as a passive transponder.

The RFID tag 6 can be arranged to be readable only within a maximum distance from the RFID tag 6, wherein the maximum distance is less than about 20 cm. The maximum distance can be less than about 10 cm, 5 cm, 4 cm or 3 cm. The RFID tag can be arranged to operate in accordance with the Near Field Communication (NFC) standards.

When using NFC to read the data storage, other types of NFC targets may be used including tags, stickers, key fobs, or cards that do not require batteries.

### User Terminal

The user terminal 10 may be any user terminal device or collection devices that may host or support a user interface 14 and be able to electromagnetically interrogate the data storage 5. The user terminal 10 may include other components such as one or more electronic memory devices and processor devices that can be used to perform computation operations and run one or more software programs. The software programs may include a number of different modules or engines such as an operating system and other software used to: support the functioning of the user interface (such as a graphical user interface (GUI)); support the interrogation capability of the user terminal (such as having NFC compliant functionality). The terminal preferably runs a software application configured to process the received data from the data storage 5 and initiate a computer generated operation as a result, for example connecting to an accessing a remote program interface through a communications device within the terminal 10.

The user terminal 10 may also include user input/output components to allow a user to interact with the user terminal 10. An example of a input device is a keyboard or mouse, an example of a output device is a display, whilst an example of a dual input/output device is a touch panel display such as that on a smart mobile phone. The user terminal may also comprise one or more communication devices allowing the terminal 10 to communicate with the remote processor 12. The communication device may be the same device used to interrogate the data storage 5 or may be a different device.

The electromagnetic interrogator device 16 may be any electromagnetically interrogating device 16 comprising one or more components that, together, are configured to output interrogating electromagnetic signals and receive corresponding signals resulting from the output signals.

An example of an electromagnetic interrogator device 16 include antennae, for example, including receiving/transmitting antennae or combined transceiver antennae, electronically linked to driving and receiving electronic circuitry. Another example of an electromagnetic interrogator device 16 is a smart watch having antennae and a data communicator configured to transmit data from the smart watch to the processor within user terminal 10.

The antennae may be operated in accordance with NFC protocols and techniques. They may operate within the globally available and unlicensed radio frequency ISM band of 13.56 MHz. Most of the RF energy may be concentrated in the allowed ±7 kHz bandwidth range. The full spectral envelope used in NFC may be as wide as 1.8 MHz, for example when using ASK modulation. Data rates of operation may include but are not limited to any of: 106, 212 or 424 kbit/s. Any suitable communications protocols and data exchange formats may be used, for example: existing radio-frequency identification (RFID) standards including ISO/IEC 14443 and FeliCa.

The NFC communication may take any suitable mode including passive and active modes. In a passive communication mode, the interrogator 16 provides a carrier field and the data storage 5 answers by modulating the existing field. In this mode, the data storage 5 may draw its operating power from the interrogator-provided electromagnetic field, thus making the data storage device 5 a transponder. In an active communication mode, both interrogator 16 and data storage 5 communicate by alternately generating their own fields. A device deactivates its RF field while it is waiting for data. In this mode, both devices typically have power supplies.

The NFC communication may conform to any suitable standard (such as ECMA-340 and ISO/IEC 18092). Such standard typically specify the modulation schemes, coding, transfer speeds and frame format of the RF interface of NFC devices, as well as initialization parameters required for initialization data collision-control for both passive and active NFC modes.

FIG. 2a shows one example where a user terminal 10 is a mobile device 18 having a touch screen to support a user interface 14 and an antennae (not shown) for interrogating an RFID 6.

FIG. 2b shows an example where a user terminal 10 is a static user terminal 28 having a display to support a user interface 14. The terminal 28 in this example is in communication with a portable RFID reader 30 that a user can use to interrogate an RFID 6.

The user interface 14 may in principle be any junction between a user and a computer system comprising a set of commands or menus through which a user communicates with a system performing one or more computations. The interface may be a mechanical user interface with control features and a feedback mechanism to allow the user to navigate the interface. Additionally or alternatively the interface 14 may be a GUI output by a graphical display, such as the display on a mobile device 18. The GUI may comprise a number of alternative configurations providing different interactive options (also referred to as GUI pages or forms). As such different GUI pages may be provide to the user terminal. These may also be termed as different user interfaces.

### Processor

The processor 12 can be any suitable computer processing device and may be part of a computer system such as a server 22 as shown in FIG. 2a. References to ‘server’ throughout may equally apply to any suitable computing system. The processor 12 (hence server 22) is remote from the user terminal 10 in that it is spatially separated such that any data or other information shared between the terminal 10 and processor 12 must be transmitted and received using communication devices. The communication device on the user terminal 10 may be, for example, an antennae (not shown), which may be the same antennae used to interrogate the data storage. The communications device 26 used by the server 22 to communicate with remote devices may be any suitable may be any suitable communication device. The communication between the server 22 and the user terminal may be: through any numbers of suitable transmission media and protocols, including wired and wireless transmissions.

A shown in FIGS. 2a and 2b, the server may have one or more memory devices 24 that together with the processor 12, and any other suitable computer components, run a one or more programs configured to perform a plurality of different computational operations. Such programs may include an operating system and a program accessible via a remote user interface 14 such as a website hosted by the server 22. The user interface 14 may be provided to the user terminal via data communications between the server 22 and terminal 14. The user interface may be communicated from the server 22 to the user terminal upon the user terminal

The various computational operations performed by the one or more programs run by the processor 12 may be associated with the data stored on the storage 5. Some computations may only be performed after another computation has been performed. The user may initiate accessing a particular program run by the server in any way including manually typing in a website address. The user may also initiate accessing the program via interrogating a suitable data storage 5 with their user terminal.

Computations may include any one or more of, but not limited to, the following.

An example of a computation performed by the processor 12 is the registration of a user with a program run by the server. The registration computation requires user data input via the user interface 14. FIG. 4a shows an example of a user interface uploaded from the server 22 to the user terminal 10 to allow the user to input the data. The user interface 14 in this example is a GUI displaying graphical image objects 36, 38 wherein one of the objects is an interactive button 36 that the user may select (for example by clicking a mouse or touching a touch sensitive display panel) to initiate the registration process. The process for registering the user may comprise one or more computations. The selection of the registration button may provide the user with another user interface page to provide additional information such as sex, age, name and address. Alternatively the button 36 may cause one or more computations to be performed to automatically register the user, for example by retrieving user stored within the user terminal 10 and uploading the retrieved data to the server via the user interface 14. After registration the processor 12 may generate a username and password that is sent to the user terminal and displayed to the user via the GUI and/or stored by the user terminal (for example as a cookie).

An example of a computation performed by the processor 12 is the logging in of a registered user to use a program run by the server. The login computation requires user data input via the user interface 14. FIG. 4b shows an example of a user interface uploaded from the server 22 to the user terminal 10 to allow the user to input the data. The user interface 14 in this example is a GUI displaying graphical image objects 38 and 40 wherein one of the objects is an interactive button 40 that the user may select (for example by clicking a mouse or touching a touch sensitive display panel) to initiate the login process. The process for logging in the user may comprise one or more computations. The selection of the log in button 40 may provide the user with another user interface page to provide additional information such as username and password. Alternatively the button 36 may cause one or more computations to be performed to automatically log in the user, for example by retrieving stored data (such as user name and password) within the user terminal 10 and uploading the retrieved data to the server via the user interface 14. The computational operation of registering a user, as described above, may automatically log the user in as well. The log in operation may be a separate operation that is performed when the user is trying to access the computer program run by the server 22 for a consecutive time after the first.

An example of a computation performed by the processor 12 is one requiring data input by a registered and logged in user (via the user interface 14). Once a user has successfully accessed the program, they may navigate any options that the program presents to the user via the interface 14. The program may request, require or otherwise offer a user to interact with the program to complete a task. Tasks may include rating a product associated with a data storage that the user interrogated with their user device to initiate access to the program. FIG. 5 shows an example of a user interface uploaded from the server 22 to the user terminal 10 to allow the user to input the data required for completing the task of rating the product. The user interface 14 in this example is a GUI displaying graphical image objects 38 and 42 wherein one of the objects is an interactive button 42 that the user may select (for example by clicking a mouse or touching a touch sensitive display panel) to initiate completion of the task.

Other computational operations may not require user input via a user interface. An example of such a computation is the processing of data uploaded from the user terminal to the server. This upload may be initiated by any means including upon the user terminal receiving data from the data storage upon a successful data storage interrogation. Software running on the user terminal 10, such as an operating system and/or driver software enabling NFC capability, may be configured to process the data and identify certain information with the received that the terminal can use to perform a task. Such tasks may be the automatic connection to a program (via a website) run by the server. Other tasks may include: the user terminal 10 recording a time stamp of when the interrogation took place; the user terminal obtaining location data (for example GPS data). An example of processing this uploaded data may be the extraction of one or more values from the uploaded data and conditional use of that value within the program, for example, if a unique product identifier is uploaded to the server, the computation process may extract a numeric points value associated with the data and store the points vale in a database that accumulates similar points. If the unique identifier has not been previously uploaded to the program then the extracted points value is entered into the database. If however the unique identifier has been previously uploaded to the program (either by the same user or another user), then the extracted points value may not be included in the database or may be modified or assigned a particular flag to the second uploaded points value.

Other information within the received data may be identified as data for storage or data for uploading to the program run by the server. Such data could be a unique product code associated with the product that the data storage was affixed to or contained within. The upload of this information may be performed when the user terminal first accessed the program upon the interrogation or it may be performed on a subsequent transmission of data from the terminal 10 to the server 22, for example, the program may send a request to upload this information.

‘In order to address various issues and advance the art, the entirety of this disclosure shows by way of illustration various embodiments in which the claimed invention(s) may be practiced and provide for superior methods and Apparatus for providing a user interface. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.’

1. A method for providing a user interface to a user terminal based on an electromagnetic interrogation of one or more interrogatable data storage devices;
the method comprising the steps of:
receiving first data output from a user terminal associated with a first electromagnetic interrogation of an interrogatable data storage;
outputting a first user interface to the user terminal based on the first data;
receiving second data output from the user terminal, the second data associated with a second electromagnetic interrogation of an interrogatable data storage;
outputting a second user interface to the user terminal, the second user interface being different to the first user interface and based on:
the second data and,
data associated with the receiving of the first data.

2. A method as claimed claim 1 wherein:
the first user interface is configured to receive user data for interacting with a program associated with the user interface;
the second data comprises data associated with the user data.

3. A method as claimed in any of claims 1-2 comprising the steps of:
upon outputting the first user interface to the user terminal,
receiving user data input through the first user interface;
performing a first computational operation using the user data;
wherein the second user interface is further based upon the performance of the first computational operation.

4. A method as claimed in any of claims 1-3 wherein the steps of receiving first and second data and outputting first and second user interfaces are performed using one or processors remote from the user terminal.

5. A method as claimed in claim 4 wherein the one or more processors comprise part of a remote system running a user interactive program accessible through the first and second user interfaces.

6. A method as claimed in any of claims 1-5 wherein the user terminal is a mobile user device.

7. A method as claimed in any of claims 1-6 wherein the one or more interrogatable data storages comprises interrogatable data configured to instruct the receiving user terminal to output the corresponding first or second data.

8. A method as claimed in any of claims 1-7 wherein the one or more interrogatable data storages comprises interrogatable data configured to instruct the receiving user terminal to determine location data associated with the user terminal.

9. A method as claimed in any of claims 1-8 wherein the one or more interrogatable data storages comprises interrogatable data configured to instruct the receiving user terminal to determine time value associated with the interrogation of the corresponding data storage.

10. A computer readable product comprising instructions configured to give effect to the method as claimed in any of claims 1-9.

11. An apparatus for providing a user interface to a user terminal based on an electromagnetic interrogation of one or more interrogatable data storage devices; the apparatus comprising a processor and configured to:
receive first data output from a user terminal associated with a first electromagnetic interrogation of an interrogatable data storage;
output a first user interface to the user terminal based on the first data;
receive second data output from the user terminal, the second data associated with a second electromagnetic interrogation of an interrogatable data storage;
output a second user interface to the user terminal, the second user interface being different to the first user interface and based on:
the second data and,
data associated with the receiving of the first data.

12. A system comprising the apparatus as claimed in claim 11 and the user terminal.

13. A method for providing a user interface configured to initiate user access to an interactive session with a program;
the method comprising the steps of:
receiving first data from a first user terminal, the first data associated with a first electromagnetic interrogation of an interrogatable data storage;
providing a first user interface to the first user terminal, the first user interface configured to initiate user access to a first interactive session with the program, the first interactive session based upon the first data;
receiving second data from a second user terminal; the second data associated with a second electromagnetic interrogation of an interrogatable data storage;
determining a state of the first interactive session;
providing a second user interface to the second user terminal, the second user interface configured to initiate user access to a second interactive session with the program, the second interactive session based upon:
the determined state of the first interactive session; and,
the second data.

14. A method as claimed in 13 where state of the first interactive session may be any of:
I) not having started;
II) started but not yet completed;
III) completed.

15. A method as claimed in claim 14 wherein the user terminal comprises a memory; the method comprising the step of storing data associated with the determined state of the first interactive session in the memory.

16. A method as claimed in any of claims 13 to 15 wherein
the first interactive session comprises a first computational operation using the first data; and,
the second interactive session comprises a second computational operation:
using the second data; and,
based upon the first computational operation.

17. An apparatus for providing a user interface configured to initiate user access to a first interactive session with a program;
the apparatus comprising a processor, the apparatus configured to:
receive first data from a first user terminal, the first data associated with a first electromagnetic interrogation of an interrogatable data storage;
provide a first user interface to the first user terminal, the first user interface configured to initiate user access to a first interactive session with the program, the first interactive session based upon the first data;
receive second data from a second user terminal; the second data associated with a second electromagnetic interrogation of an interrogatable data storage;
determine, using the processor, a state of the first interactive session;
provide a second user interface to the second user terminal, the second user interface configured to initiate user access to a second interactive session with the program, the second interactive session based upon:
the determined state of the first interactive session; and,
the second data.

18. A system comprising an apparatus as claimed in any of claims 13-17 and the first and second user terminals.

19. A method for outputting data from a user terminal;
the method comprising the steps of:
receiving storage data from an interrogatable data storage upon the electromagnetic interrogation of the data storage by the user terminal;
in any order:
determining any of:
location based data associated with the user terminal; and/or
time based data associated with the interrogation of the interrogatable data storage
establishing a communication link between the user terminal and a remote computer system based on the storage data;
outputting the determined data to the remote computer system.

20. A method as claimed in claim 19 wherein the remote system is configured to run a program; the method comprising the steps of:
providing a user interface to the user terminal for interacting with the program, upon establishing a communication with the remote computer system.

21. A method as claimed in claim 19 or 20 wherein the user interface is configured to determine the location or time based data.

22. A user terminal comprising a processor configured to perform the method as claimed in any of claims 19-21.

23. Packaging for a smoking article, the packaging comprising an electromagnetically interrogatable data storage; the interrogatable data storage configured to output data upon electromagnetic interrogation by an electromagnetic interrogator associated with a user terminal; the output data configured to instruct the user terminal to:
establish a communication link to a remote processor; and
determine any of:
I) user terminal location data;
II) timing information associated with the electromagnetic interrogation; for outputting to the remote processor.

24. Packaging as claimed in claim 23 wherein the electromagnetically interrogatable data storage comprises an RFID.

25. Packaging as claimed in any of claims 23-24 wherein the data output, upon electromagnetic interrogation, comprises a website address.

26. Packaging as claimed in any of claims 23-25 wherein the data output, upon electromagnetic interrogation, comprises identification data associated with the packaging.
